(19) United States
(12) Patent Application Publication
(10) Pub. No.: US 2015/0044577 A1
(43) Pub. Date: Feb. 12, 2015

(54) MAGNESIUM ION-CONTAINING ELECTROLYTE

(71) Applicants: DENSO CORPORATION, Kariya-city (JP); Mrecell, LLC, Kyiv (GB)

(72) Inventors: Norikazu ADACHI, Nagoya-city (JP); Kenichirou KAMI, Takahama-city (JP); Sergiy M. MALOVANYY, Kyiv (GB); Leonid M. USHKALOV, Kyiv (GB)

(21) Appl. No.: 14/451,800

(22) Filed: Aug. 5, 2014

(30) Foreign Application Priority Data
Aug. 7, 2013 (JP) 2013-164360

(51) Int. Cl. H01M 10/0568; H01M 10/054; H01M 10/0569

(52) U.S. Cl. CPC H01M 10/0568; H01M 10/0569; H01M 10/054; H01M 2300/002
USPC 429/337; 429/200; 429/341

(57) ABSTRACT

A magnesium ion-containing electrolyte used for a magnesium cell includes magnesium, halogen, one of boron, aluminum, and phosphorous, and an organic group including OC_{X}H_{Y}. The magnesium ion-containing electrolyte has low reactivity with oxygen. Even when oxygen exists in the magnesium ion-containing electrolyte, a deterioration of the magnesium-ion containing electrolyte is restricted, and magnesium ions stably move.

### CROSS REFERENCE TO RELATED APPLICATIONS

The present application is based on and claims priority to Japanese Patent Application No. 2013-164360 filed on Aug. 7, 2013, the contents of which are incorporated in their entirety herein by reference.

### TECHNICAL FIELD

The present disclosure relates to a magnesium ion-containing electrolyte used for a magnesium cell.

### BACKGROUND

A magnesium (Mg) cell is discharged or charged by reduction or oxidation reaction of high-potential Mg ions at a positive electrode and oxidation or reduction reaction of low-potential Mg ions at a negative electrode. The magnesium cell theoretically has high voltage and high capacity. However, in order to realize high voltage and high capacity, the magnesium cell needs an electrolyte that enables oxidation-reduction reaction at the positive electrode and the negative electrode and enables stable movement of Mg ions (see, for example, JP-A-2007-188709).

In a magnesium cell disclosed in JP-A-2007-188709, a material based on Grignard reagent is used as an electrolyte that enables oxidation-reduction reaction of a Mg metal negative electrode and enables movement of Mg ions. However, the magnesium cell has problems in oxidation resistance and stability. In addition, the conventional electrolyte has high reactivity with oxygen and is decomposed when oxygen exists. Thus, in an oxygen atmosphere, it is difficult to handle the electrolyte and to manufacture the magnesium cell. In addition, an electrolyte having high reactivity with oxygen cannot be used as an electrolyte for an air cell that uses oxygen in a reaction.

### SUMMARY

It is an object of the present disclosure to provide a magnesium ion-containing electrolyte that has low reactivity with oxygen.

A magnesium ion-containing electrolyte according to an aspect of the present disclosure includes magnesium, halogen, one of boron, aluminum, and phosphorous, and an organic group including OCₓH_{y}.

The magnesium ion-containing electrolyte has low reactivity with oxygen. Thus, even when oxygen exists in the electrolyte, a deterioration of the magnesium ion-containing electrolyte is restricted, and magnesium ions are stably transferred. Therefore, the magnesium ion-containing electrolyte can be suitably used for a magnesium-air cell that uses a reaction with oxygen.

### BRIEF DESCRIPTION OF THE DRAWINGS

Additional objects and advantages of the present disclosure will be more readily apparent from the following detailed description when taken together with the accompanying drawings. In the drawings:

FIG. 1 is a diagram illustrating a configuration of a magnesium cell according to a first embodiment of the present disclosure;

FIG. 2 is a diagram illustrating a chemical reaction in the magnesium cell;

FIG. 3 is a flowchart illustrating a manufacturing method of a positive electrode;

FIG. 4 is a flowchart illustrating a manufacturing method of the magnesium cell;

FIG. 5 is a diagram illustrating ions in an electrolyte according to the first embodiment in a simplified manner;

FIG. 6 is a flowchart illustrating an evaluation method of the electrolyte; and

FIG. 7 is a diagram illustrating evaluation results.

### DETAILED DESCRIPTION

### First Embodiment

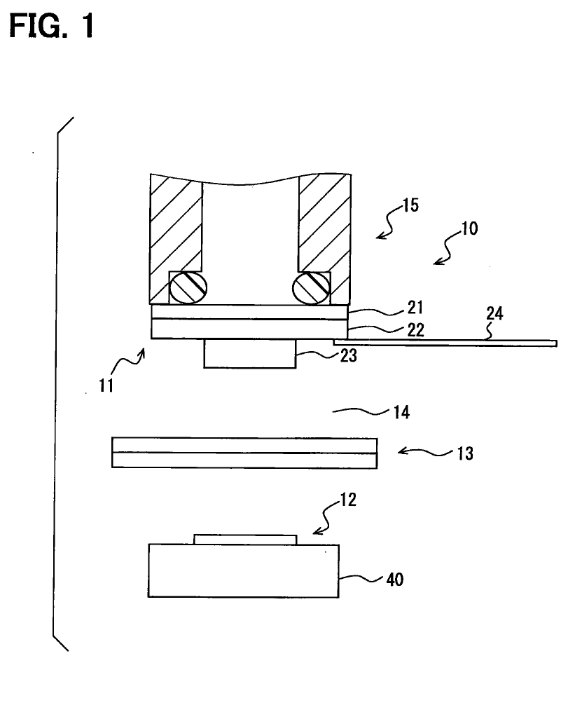

A first embodiment of the present disclosure will be described with reference to FIG. 1 through FIG. 7. A magnesium cell 10 is also called a magnesium-air cell and is a kind of an air cell. The magnesium cell 10 according to the present embodiment includes a positive electrode 11, a negative electrode 12, a separator 13, a magnesium ion-containing electrolyte 14, a gas supplier 15, and a case (not illustrated).

The positive electrode 11 includes a polytetrafluoroethylene (PTFE)-treated carbon paper 21, a mesh 22 made of nickel (Ni), and a positive electrode catalyst 23 stacked in this order. The positive electrode 11 is also called as an air electrode and is made of material that can reduce oxygen. At an attachment portion of the positive electrode 11 and the gas supplier 15, the PTFE-treated carbon paper 21 is disposed. The positive electrode 11 is connected to a lead wire 24 for extracting electric current. The lead wire 24 is made of, for example, nickel (Ni).

As illustrated in FIG. 1, the positive electrode 11 and the negative electrode 12 are stacked through the separator 13 in such a manner that the positive electrode 11 is separated from the negative electrode 12. The negative electrode 12 is made of material including magnesium.

The separator 13 is made of insulation material in which electrolyte is movable. For example, a nonwoven fabric or porous layer made of polyolefin or a resin, such as fluorocarbon polymer, can be used as the separator 13. Specifically, the resin includes polyethylene, polypropylene, polytetrafluoroethylene, and polyvinylidene fluoride. The separator 13 according to the present embodiment is made by stacking two plates made of polyethylene and each having a thickness of 0.025 mm.

The magnesium ion-containing electrolyte (also simply referred to as “electrolyte”) 14 includes at least a solvent and a salt and is in contact with the positive electrode catalyst 23 and the negative electrode 12. The electrolyte 14 includes magnesium, halogen, one of boron, aluminum, and phosphorous, and an organic group including OCₓH_{y}. Each of X and Y in OCₓH_{y} represents a positive integral number. Preferably, the solvent of the electrolyte 14 includes ether. More preferably, the solvent includes at least one of tetrahydrofuran (THF), diglyme, and tetraglyme. Preferably, the halogen includes at least one of chlorine (Cl) and bromine (B). The electrolyte 14 may further include a metal complex that includes halogen, one of boron, aluminum, and phosphorus, and OCₓH_{y}.

In the case, the positive electrode 11, the negative electrode 12, the separator 13, and the electrolyte 14 are housed. The case is made of material that does not react with the negative electrode 12, the positive electrode 11, and the electrolyte 14. The case restricts the electrolyte 14 from leaking outside.

The gas supplier 15 supplies oxygen to the positive electrode 11 from outside the case. The gas supplier 15 supplies pure oxygen to the positive electrode 11 from an oxygen tank (not illustrated) filled at, for example, 0.01 MPa. Accordingly, the positive electrode catalyst 23 is supplied with oxygen passing through the PTFE-treated carbon paper 21 and the mesh 22.

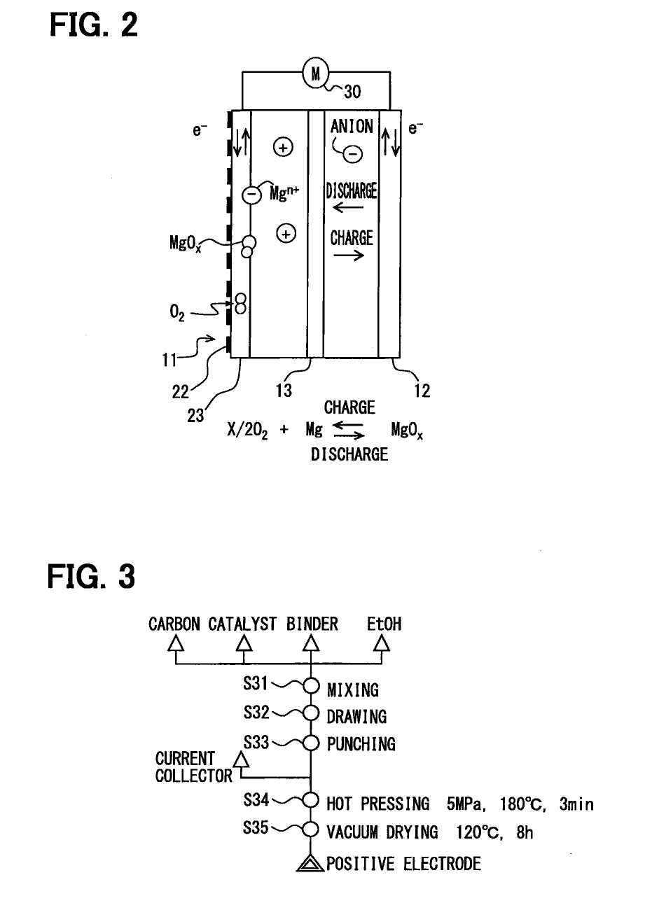

When oxygen is supplied and a load 30 is connected to discharge the magnesium cell, as illustrated in FIG. 2, Mg of the anode material in the electrolyte 14 is oxidized into Mg²⁺ cation. Accordingly, Mg²⁺ cations move in the electrolyte 14 from the negative electrode 12 to the positive electrode 11, MgOₓ is formed and the magnesium cell 10 is dischaged. In contrast, the cell is connected to charge the magnesium cell 10, MgOₓ is reduced, and Mg²⁺ cations move in the electrolyte 14 from the positive electrode 11 to the negative electrode 12.

Next, a manufacturing method of the positive electrode 11 will be described with reference to FIG. 3. Firstly, carbon, a catalyst, a binder, ethanol (EtOH), and a current collector are prepared. As carbon, for example, ECP600JD manufactured by KB may be used. As the catalyst, for example, electrolytic manganese dioxide (MnO₂) may be used. The electrolytic manganese dioxide may be, for example, FMH manufactured by Tosoh Corporation. As the binder, for example, D-2CE manufactured by Daikin Chemical Industries, Ltd. may be used. Weight ratios of carbon, the catalyst, and the binder are, for example, 70 wt %, 20 wt %, and 10 wt %, respectively. The current collector is formed by stacking the mesh 22 made of nickel and the PTFE-treated carbon paper 21.

Next, at S31, carbon, the catalyst, and ethanol (EtOH) are mixed, and then at S32, the mixed material is treated by a drawing process. At S33, the drawn material is treated by a punching process, and then at S34, the punched material and the current collector are stacked, and the stacked material is treated by a hot pressing. The hot pressing may be performed, for example, at 5 MPa and 180° C. for 3 minutes. Then, at S35, a vacuum drying is performed to complete the positive electrode 11. The vacuum drying may be performed, for example, at 120° C. for 8 hours. The positive electrode 11 is manufactured by the above-described method.

Next, a manufacturing method of an electrolyte 14 according a first example of the present embodiment will be described. The electrolyte 14 is manufactured, for example, in a glove box filled with inert gas. A stirring in a manufacturing process is performed in a flask with a magnetic stirrer. Firstly, a salt and a solvent are prepared as materials. The salt is 2 mol/L of PhMgCl solution in THF and is 7.815 g. The solvent is 38 g of diglyme and has a water content of 30 ppm or less.

The salt and the solvent are mixed and are stirred for about 2 hours. Next, the mixed material is added with 2.19 g of B(OEt)₃ and is stirred for 15 minutes. Furthermore, the mixed material is stirred for about 1.5 hours while 2 mol/L of PhMgCl/THF is dropped. Thus, 2 mol/L of PhMgCl/THF is mixed in two steps. Because the mixing causes heat generation, PhMgCl/THF is dropped little by little. After that, the mixed material is further stirred for about 5 hours to manufacture the electrolyte 14 according to the first example.

The electrolyte 14 according to the first example manufactured by the above-described method becomes 0.3 mol of Mg[(OEt)₃, Ph₁, B₁, Cl₁]/THF (15) diglyme (85). Thus, the electrolyte 14 according to the first example includes magnesium, chlorine (Cl) as halogen, boron, and OEt as an organic group including OCₓH_{y} and Ph as an organic group R. In addition, the electrolyte 14 according to the first example is made of raw materials including boron and the organic group including OCₓH_{y}.

Next, a manufacturing method of an electrolyte 14 according to a second example of the present embodiment will be described. The electrolyte 14 is manufactured, for example, in a glove box filled with inert gas. A stirring in a manufacturing process is performed in a flask with a magnetic stirrer. Firstly, a salt and a solvent are prepared as materials. The salt is 2 mol/L of PhMgCl/THF and is 10.4 g. The solvent is 24 g of THF and has a water content of 30 ppm or less.

The salt and the solvent are mixed and are stirred for about 1 hour. Next, the mixed material is stirred for about 1.5 hours while 1.13 g of AlCl₃ is dropped. Furthermore, the mixed material is stirred for about 5 hours. Next, the mixed material is added with 8 g of tetraglyme and is stirred for about 5 hours. Furthermore, the mixed material is added with 0.94 g of C₆H₅OH and 6 g of C₆H₅CH₃ and is stirred for about 5 hours. Accordingly, the electrolyte 14 according to the second example is manufactured.

The electrolyte 14 according to the second example manufactured by the above-described method becomes 0.4 mol/L of Mg₂[Phₓ, OPh_{y}, Al₁, Cl₅]/THF (80) tetraglyme (20). Thus, the electrolyte 14 according to the second example includes magnesium, chlorine (CI) as halogen, aluminum, and OPh as an organic group including OCₓH_{y} and Ph as an organic group R. In addition, the electrolyte 14 according to the second example is made of raw materials including aluminum and an organic group including OCₓH_{y}.

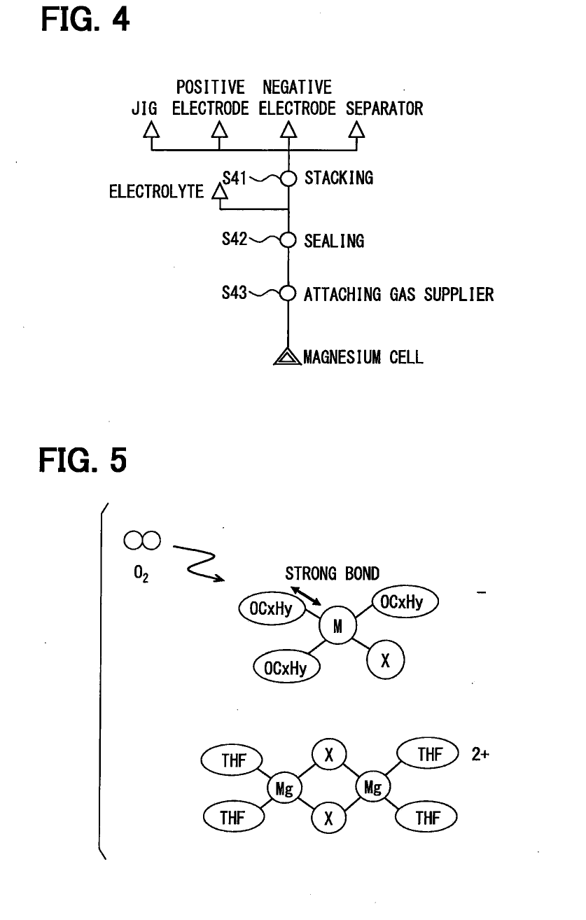

Next, a manufacturing method of the magnesium cell 10 will be described with reference to FIG. 4. Firstly, a jig 40, the positive electrode 11, the negative electrode 12, the separator 13, and the electrolyte 14 are prepared. At S41, as illustrated in FIG. 1, the negative electrode 12, the separator 13, and the positive electrode 11 are stacked on the jig 40 in this order. At S42, the electrolyte 14 according to the first example or the second example and the stacked components are sealed in the case. At S43, the gas supplier 15 is attached to the positive electrode 11. Accordingly, the magnesium cell 10 illustrated in FIG. 1 is manufactured.

Next, characteristics of the magnesium cell 10 according to the present embodiment will be described with reference to FIG. 5. In FIG. 5, halogen is represented by X, and boron (B), aluminum (Al), or phosphorous (P) is represented by M as a center metal. As described above, the electrolyte 14 according to the present embodiment includes a complex that includes Mg, X (Cl, Br), M (B, Al, P) and OCₓH_{y}. In an anion, the center metal M is strongly bonded with a ligand (OCₓH_{y}). Thus, when the ligand (OCₓH_{y}) having high bonding strength with the center metal M (B, Al, or P) is used, a coordinate structure is not broken even when oxygen is mixed.

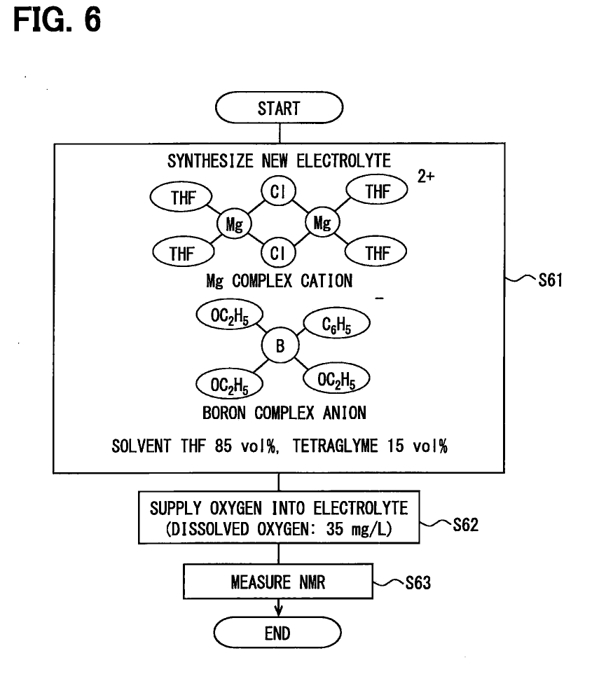

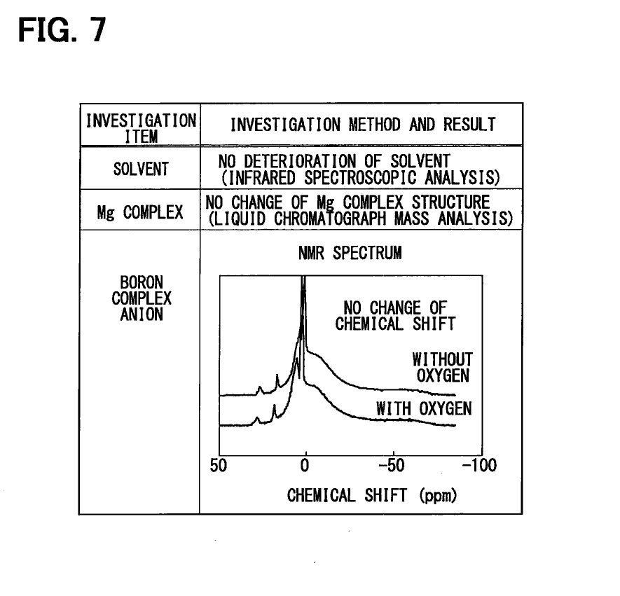

Next, an evaluation of the electrolyte 14 according to the present embodiment will be described with reference to FIG. 6 and FIG. 7. At S61, the electrolyte 14 is prepared. The electrolyte 14 includes Mg complex cation, and boron complex anion. The electrolyte 14 further includes THF 15 vol % and diglyme 85 vol % as a solvent. Thus, the electrolyte 14 according to the present embodiment includes a complex that includes Mg, Cl, B, and OC₂H₅. At S62, oxygen is supplied to the electrolyte 14 in such a manner that dissolved oxygen becomes 35 mg/l. At S63, various measurements including nuclear magnetic resonance (NMR) is performed, and the present flow ends.

As illustrated in FIG. 7, after oxygen is supplied at S62, states of the solvent, the Mg complex, and the boron complex anion, are investigated. As a result of an infrared spectroscopic analysis, a deterioration of the solvent is not observed. As a result of a liquid chromatograph mass analysis, a structure of the Mg complex is not observed.

The NMR measurement is performed with respect to the boron complex anion. As a result, a change in chemical shift is not observed between before oxygen is supplied (without oxygen) and after oxygen is supplied (with oxygen). If the boron complex anion reacts with oxygen, a waveform of the chemical shift changes. Thus, from the result of the NMR measurement, it is clear that a reaction between oxygen and the boron complex anion is restricted.

Next, the magnesium cell 10 is evaluated using each of the electrolytes 14 according to the first example and the second example, and electrolytes according to first through third comparative example. The table 1 shows the evaluation results. With respect to the magnesium cell 10 using each of the electrolytes, a constant-current discharge is performed with electric current of 0.01 mA/cm² while a voltage changes from 2 V to 0.5 V.

TABLE 1

| | | | | DISSOLVING | | |
|---|---|---|---|---|---|---|
| | | | OXIDATIVE | EDUCING | REACTIVITY | AIR CELL |
| | | | DECOMPOSITION | EFFICIENCY | WITH | CAPACITY |
| | SALT | SOLVENT | POTENTIAL (V) | OF Mg (%) | OXYGEN | (mAh/g) |
| FIRST | Mg[(OEt)₃,Ph₁,B₁,Cl₁] | THF(15) | 3.1 | 97 | LOW | 1300 |
| EXAMPLE | | DIGLYME(85) | | | | |
| SECOND | Mg₂[Phₓ,OPh_{y},Al₁,Cl₅] | THF(80) | 2.7 | 88 | LOW | 140 |
| EXAMPLE | | TETRAGLYME(20) | | | | |
| FIRST | Mg₂[(C₆H₄CH₃)₂,Al₁,Cl₅] | THF(80) | 3.1 | 98 | HIGH | 1 |
| COMPARATIVE | | TETRAGLYME(20) | | | | |
| EXAMPLE | | | | | | |
| SECOND | Mg(AlCl₂BuEt)₂ | THF | 2.1 | 95 | HIGH | — |
| COMPARATIVE | | | | | | |
| EXAMPLE | | | | | | |
| THIRD | Mg(AlCl₃Bu)₂ | THF | 2.4 | 75 | HIGH | — |
| COMPARATIVE | | | | | | |
| EXAMPLE | | | | | | |

Firstly, a manufacturing method of the electrolyte according to the first comparative example will be described. The electrolyte is manufactured, for example, in a glove box filled with inert gas. A stirring in a manufacturing process is performed in a flask with a magnetic stirrer. As a material, 1 mol/L of C₆H₄CH₃MgCl/THF, which is 38.24 g, is prepared.

Then, the material is stirred for about 2 hours while 2.26 g of AlCl₃ is dropped. After the mixed material is further stirred for about 5 hours, 8 g of tetraglyme is added, and the mixed material is further stirred for about 5 hours. Accordingly, the electrolyte according to the first comparative example is manufactured.

The electrolyte according to the first comparative example manufactured by the above-described method becomes 0.8 mol/L of Mg₂[(C₄H₄CH₃)₂, Al,, CI₅]/THF (80) tetraglyme (20). Thus, the electrolyte according to the comparative example includes magnesium, chlorine (CI) as halogen, and aluminum, but without an organic group including OCₓH_{y}.

As shown by the table 1, each of the electrolytes 14 according to the first example and the second example has low reactivity with oxygen, and each of the electrolytes according to the first through third comparative examples has high reactivity with oxygen. In addition, it is clear that each of the electrolytes 14 according to the first example and the second example has a large air cell capacity.

As described above, the electrolyte 14 according to the present embodiment includes the complex that includes Mg, halogen X (Cl, Br), one of boron (b), aluminum, and phosphorous (P), and OCₓH_{y}. The conventional electrolyte is based on a Grignard reagent RMgX (R represents an alkyl or an aryl, X represents fluoride, chloride, or bromide). Thus, a bonding force between a center metal and an organic group (R) is small. If oxygen is mixed, the complex reacts with oxygen and a coordinate structure is broken. In other words, in the conventional electrolyte, reactivity between oxygen and the organic group (R) is high. Thus, if oxygen is mixed, the conventional electrolyte may be decomposed.

In contrast, the electrolyte 14 according to the present embodiment restricts the reactivity with oxygen, enables oxidation-reduction of the Mg metal negative electrode 12 and the positive material, and enables movement of Mg ions. Thus, the electrolyte 14 can be easily handled and can be used for the magnesium cell 10 that uses reaction with oxygen. In other words, the electrolyte 14 according to the present embodiment has a higher conductivity of Mg ions, a higher efficiency of oxidation- reduction of Mg metal, a higher oxidation resistance, and a lower reactivity with oxygen compared with the conventional electrolyte.

### Other Embodiments

While the present disclosure has been described with reference to embodiments thereof, it is to be understood that the disclosure is not limited to the embodiments and constructions. The present disclosure is intended to cover various modification and equivalent arrangements.

For example, OCₓH_{y} may be OCₙH₂ₙ₊₁ (n represents a positive integral number), OC₆H₅, or OC₆H₄—R (R represents an organic group). Halogen other than bromine or chlorine may also be used.

What is claimed is:

1. A magnesium ion-containing electrolyte used for a magnesium cell, comprising:
magnesium;
halogen;
one of boron, aluminum, and phosphorous; and
an organic group including OCₓH_{y}.

2. The magnesium ion-containing electrolyte according to claim 1, further comprising a metal complex that includes:
the halogen;
the one of boron, aluminum, and phosphorous; and
the OCₓH_{y}.

3. The magnesium ion-containing electrolyte according to claim 1, further comprising a solvent that includes ether.

4. The magnesium ion-containing electrolyte according to claim 1, further comprising a solvent that includes at least one of tetrahydrofuran, diglyme, and tetraglyme.

5. The magnesium ion-containing electrolyte according to claim 1, wherein the halogen is chlorine.

6. The magnesium ion-containing electrolyte according to claim 1 made of raw materials that include:
one of boron and aluminum; and
an organic group including OCₓH_{y}.

7. The magnesium ion-containing electrolyte according to claim 1, further comprising an organic group R, where R represents an aryl or an alkyl.
